(19) United States
(12) Patent Application Publication
(10) Pub. No.: US 2004/0205313 A1
(43) Pub. Date: Oct. 14, 2004

(54) Method, apparatus and article for lock management

(76) Inventors: Richard L. Hudson, Florence, MA (US); Hong Wang, Fremont, CA (US); John Shen, San Jose, CA (US); Weldon Washburn, San Jose, CA (US); James M. Stichnoth, San Jose, CA (US); Sreenivas Subramoney, Palo Alto, CA (US); CHRIS NEWBURN, 8034 RENEE DRIVEI, IL (US)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/411,742

(22) Filed: Apr. 10, 2003

(51) Int. Cl. G06F 12/00

(52) U.S. Cl. 711/163; 711/152

(57) ABSTRACT

A method is provided including determining if an object has been published previously, identifying the object as public according to whether the object has been published previously, identifying objects reachable from the object as public according to whether the object has been published previously, and publishing the object. An apparatus for performing the method, and an article including a machine- accessible medium that provides instructions that, if executed by a processor, will cause the processor to perform the method are also provided.

### TECHNICAL FIELD

This disclosure relates to the management of objects that are accessible by multiple threads, and, more specifically, relates to a method, an apparatus and an article for the management of locks that may be used with objects that are accessible by multiple threads.

### BACKGROUND

It is known in the art to provide a computing device that has multiple threads operating simultaneously. A thread refers to a set of instructions executing on behalf of a user or a process, and may be associated one or more objects. In turn, an object is an instance of a class, where a class is a collection of fields and methods. The simultaneous operation of multiple threads permits, for example, a user to listen to an audio clip (associated with the operation of a first thread) while scrolling a page (associated with the operation of a second thread) and downloading an image (associated with the operation of a third thread).

Programming languages, like Java and C#, permit more than one thread to access a particular object. Objects that are accessible by only one thread may be referred to as private. Objects that accessible by more than one thread may be referred to as public. A private object may become a public object when it is published, i.e., when a reference to the object is placed in a public slot - an object slot (a field holding a pointer to an object) in a public object or a global slot (a slot that is not an object slot but that is visible to more than one thread).

If public objects could be accessed simultaneously by multiple threads, then the possibility would exist for the multiple threads to inconsistently modify the simultaneously accessed object. In turn, if the object were inconsistently modified, then execution errors could occur. Therefore, it is known in the art to provide methods to manage the access of multiple threads to a single object.

For example, when a particular thread wants to access an object that is accessible by multiple threads, a synchronization method may be used to impose an exclusive lock on the object to prevent other threads from accessing the object. That is, when a thread is about to access a public object, the synchronization method may determine if the object is available (no other threads are presently accessing the object), for example, by checking a flag associated with the object that is reserved for indicating the locked status of the object. If the object is available, then the synchronization method may further ensure that the object is accessible by only the thread presently seeking access, for example, by labeling the object such that only the thread presently seeking access can access the object.

To prevent a race situation and interleaving from occurring, the synchronization method may impose the exclusive lock just described by using an atomic level instruction, such that it appears to all threads as if the checking and labeling are not separate actions, but a single action. Otherwise, after the synchronization method has checked the object for a first thread, but before the object is labeled for the first thread, the method could check the object for a second thread and mistakenly determine that the object was still available. The second thread would be thus become interleaved with the first thread. Therefore, the synchronization method may use an atomic read modify write (RMW) instructions, such as the locked compare exchange instruction of the IA32 processor manufactured by Intel Corporation of Santa Clara, Calif., to impose the exclusive lock.

Because of the errors that might occur in the absence of the exclusive lock, the synchronization method may impose the exclusive lock on an object even if other threads would not, in fact, be attempting to access the object in question. The use of more exclusive locks than is actually necessary comes at a price. The process of acquiring a lock by using atomic RMW instructions takes up a significant amount of processor capacity, and processor capacity is finite. If many more locks are established that are necessary, then a sizeable amount of processor capacity may be misdirected and lost.

### BRIEF DESCRIPTION OF THE DRAWINGS

The disclosed methods, apparatuses and articles are illustrated more or less diagrammatically in the accompanying drawings wherein:

FIG. 1 is a block diagram of a computing device;

FIG. 2 is a flow chart illustrating a method of identifying an object as public;

FIG. 3 is a flow chart illustrating a method of identifying an object as public by moving the object to a public object memory section;

FIG. 4 is a flow chart illustrating a method of identifying an object as public by designating the area the object is in as a public object memory section;

FIG. 5 is a flow chart illustrating a method of identifying an object as public by setting a flag;

FIG. 6 is a schematic diagram of an object useable with the method of identifying an object as public according to FIG. 5; and

FIG. 7 is a flow chart illustrating a method of selecting a lock according to an object's identification.

### DETAILED DESCRIPTION

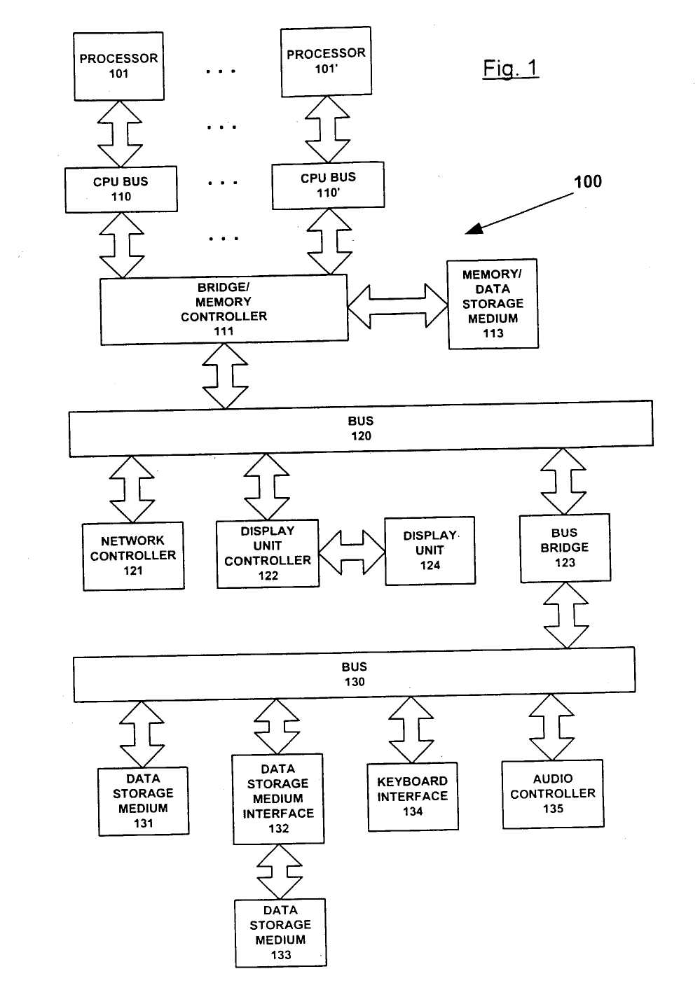

FIG. 1 shows an embodiment of a computing device 100. In particular, the computing device 100 shown in FIG. 1 may be a computer. However, this is merely by way of illustration and not by way of limitation, for the computing device 100 may also be a personal digital assistant (PDA), mobile phone, Linux machine, or any other computing device.

The computing device 100 may include processors 101 and 101′. While a single block is shown for each of the processors 101, 101′, the processors 101, 101′ may each include one or more logical processors, and/or one or more physical processors. In fact, as shown, multiple logical or physical processors may be used to take advantage of the efficiencies realized through simultaneous processing of multiple threads. Two of the processors (i.e, the first and the last) are shown for simplicity.

As shown, the processors 101, 101′ may be operatively coupled via CPU buses 110, 110′ to a bridge/memory controller 111. The bridge/memory controller 111 may, in turn, be operatively coupled to a memory/data storage medium 113. It will be recognized that elements other than buses may be used to couple the processors 101, 101′ and the memory/data storage medium 113, and it will also be recognized that this disclosure is not limited to only the arrangement shown for coupling the processors 101, 101′ to the memory/data storage medium 113.

Furthermore, the bridge/memory controller 111 may be operatively coupled to a bus 120. Via the bus 120, the bridge/memory controller 111 may be operatively coupled to a network controller 121, a display unit controller 122, and a bus bridge 123. As shown, the display device controller 122 may be operatively coupled to a display unit 124. The display unit may be a cathode ray tube (CRT), a liquid crystal display (LCD), or any other type of display unit.

The bus bridge 123 may be operatively coupled, via a bus 130, to additional elements. For example, as shown in FIG. 1, the bus bridge 123 may be operatively coupled to a data storage medium 131, a data storage medium interface 132 (e.g., a magnetic disk drive, a compact disk (CD) drive or a digital versatile disk drive (DVD) drive) and associated data storage medium 133 (e.g., a magnetic disk, a CD or a DVD), a keyboard interface 134 and an audio controller 135.

One or more programs may operate within the processors 101, 101′. For example, an operating system (OS) may be operating within the processors 101, 101′. A garbage collection (GC) program may also be operating within the processors 101, 101′. Operating in conjunction with the garbage collection program within the processors 101, 101′, and more particularly a write barrier associated with the garbage collection program, is a set of instructions for implementing a lock management method according to the present disclosure.

The operating system operating within the processors 101, 101′ may be one of a variety of systems. For example, the operating system may be one of the WINDOWS family of systems available from Microsoft Corporation of Redmond, Washington, such as WINDOWS 95, 98, 2000, ME, or XP. Alternatively, the operating system may be one of the UNIX* family of systems, originally developed by Bell Labs (now Lucent Technologies Inc./Bell Labs Innovations) of Murray Hill, N.J. and available from various sources. As a further alternative, the operating system may be an open-source system, such as the LINUX operating system. It will be recognized that still further alternative operating systems may be used.

In regard to the garbage collection program, it will be recognized at the outset that the memory requirements of a program may be managed explicitly. That is, a programmer may include instructions within a program that reserve the memory required by the operation of the program when it is needed, and then release the memory when the program no longer needs it. However, a separate program may operate within the processor to determine the memory that is presently in use by the programs operating in the processors 101, 101′ and to make available the memory that is no longer being used. The separate program may be referred to as a garbage collection program.

There are many different ways in which the garbage collection program may make the determination about the memory currently in use. For example, a counting garbage collection program may keep track of the number of references to a particular memory location, and may release the memory location when there are no references to the memory location. As an alternative, a mark-and-sweep garbage collection program may trace the objects reachable from the roots of the then-operating threads, and may mark the objects that are reachable. The mark-and-sweep garbage collection program may then review all of the objects and release the memory used by objects that are unmarked (i.e., no longer reachable from the root of one of the operating threads). As a further alternative, a copying garbage collection program may divide the memory available into two sections, or spaces, and at certain times may move those objects that are reachable (from the roots of the operating threads) from the space presently in use (the “From Space”) to the space that is presently not in use (the “To Space”). The application threads allocate objects in the “To Space” until it is full. At this time, the copying garbage collection program then reclaims the “From Space” by reversing the roles of the two spaces, i.e., the old “From Space” becomes the new “To Space” and the old “To Space” becomes the new “From Space”.

As a still further alternative, a generational garbage collection program focuses on a section of the memory where most of the recent allocations of memory have been made, and at certain times moves those objects within the focus area that are reachable from outside the focus area to a new area. To keep track of the objects that are reachable from outside the focus area, the generational garbage collection program may use a write barrier and a log, which may be in the form of a store buffer. The write barrier checks all writes to determine if an object from outside of the focus area is making reference to an object within the focus area. If a reference is being made from an object outside the focus area to an object within the focus area, this reference is recorded in the log. The garbage collection program may then review the list at the time of memory reclaimation and reallocation to determine which of the objects within the focus area to move to the new area.

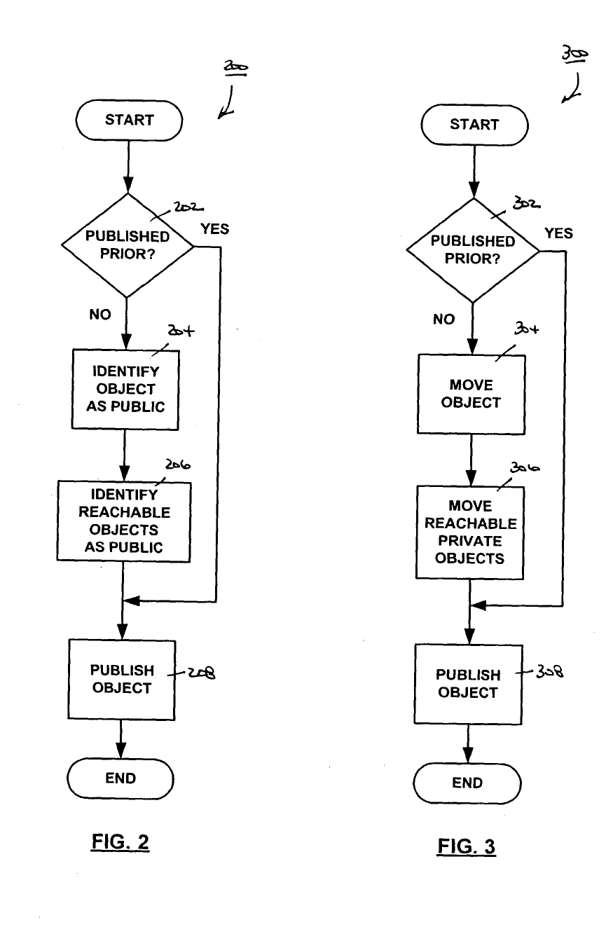

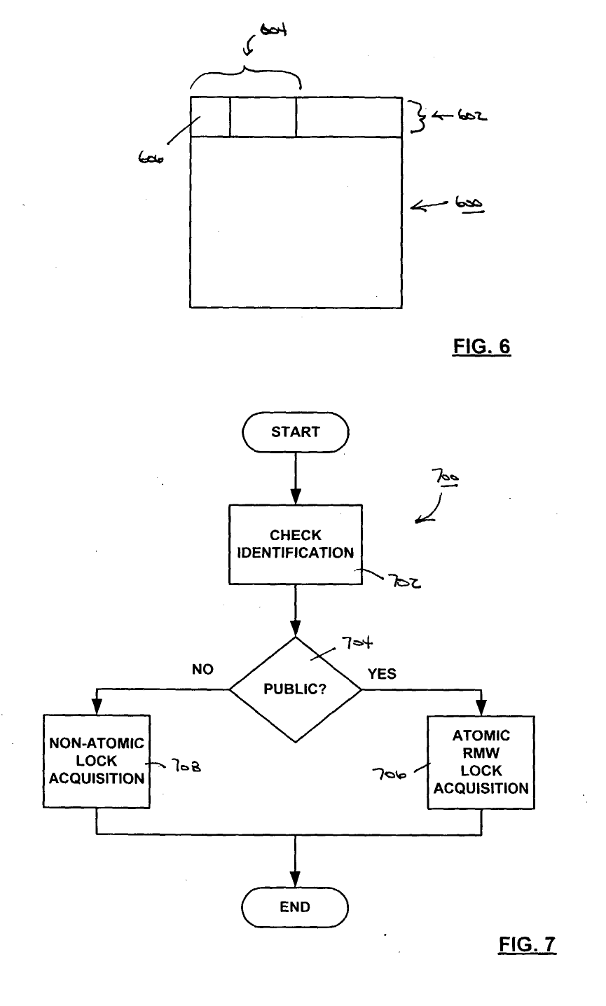

As mentioned above, operating in conjunction with the write barrier is a set of instructions for implementing a lock management method. According to the lock management method, objects that are public, and that therefore require an atomic RMW to acquire a lock to be used by a particular thread, are identified so that these objects may be differentiated from other non-public, i.e. private, objects. FIGS. 2-5 show examples of methods of identifying an object as public. Additionally, when the object is accessed by a thread, the method may check the object's identification so as to determine which lock acquisition technique to use, the atomic RMW or a non-atomic store. FIG. 7 shows an example of a method of selecting a lock according to an object's identification.

As shown in FIG. 2, according to a general example of the method 200 of identifying an object as public, the method 200 may begin with a determination at block 202 as to whether an object that is to be published, i.e., made public by placing a reference to the object in a public slot, has been published previously. The determination may occur when the write barrier, which is monitoring all writes for purposes of the garbage collection routine, determines that a write is being made to a public slot for the instant object. In preparation for this determination, each object may be associated with an identification when instantiated that the object is a private object. At block 202, the method may compare the identification associated with the object with that known to be associated with a public object, and if the object is not associated with the identification associated with a public object, the determination may be made that the object has not been published previously.

If the determination is made that this is the first publication of the object, then the method may proceed to block 204, wherein the object is now identified as a public object. As will be explained in greater detail with reference to FIGS. 3-5, there are a number of methods by which the object may be identified as a public object. Consequently, the method of identification should not be limited to only those methods shown in FIGS. 3-5, but may embrace any method of identification that may be used to differentiate one type of objects, classified as public, from those objects that are not public. After identifying the object that is to be published for the first time as public, the method may at block 206 determine those objects that are reachable from the object to be published and identify these objects as public as well, because the publication of the instant object will result in those objects being made public. After block 206, or upon a determination that the object had previously been published, the method may proceed to block 208 where the instant object is published.

As indicated above, there are many different methods by which an object may be identified as public. FIGS. 3-5 show three examples of such methods, but the method as explained with reference to FIG. 2 may embrace still other examples as well.

In FIG. 3, a method 300 is illustrated with a flowchart similar to that used in FIG. 2. At block 302, a determination may be made as to whether the instant object has been published previously. In keeping with this method 300, wherein public objects are segregated to a specific section of the memory, the public object memory section, for purposes of identification, the method may determine at block 302 whether the object to be published has already been stored in the public object memory section. If not, then the method 300 may proceed to block 304 wherein the object is moved to the public object memory section, and block 306 wherein the objects reachable from the instant object are determined and moved into the public object memory section as well. Upon completion of the block 306, or upon the determination at block 302 that the instant object has been previously published, the method 300 may proceed to block 308, whereupon the instant object is published.

One skilled in the art will recognize that the above method may be modified various ways. For example, the public objects may be segregated from the non-pubic objects without movement of the public objects into a specific section of the memory reserved for public objects. Instead, for example, the non-public objects may initially start out segregated in a specific section of the memory, and then be moved out of the reserved section when the object is published. Likewise, the private object may be moved to a private area, leaving only public objects.

In FIG. 4, a method 400 is illustrated with a flowchart similar to that used in FIGS. 2 and 3. At block 402, a determination may be made as to whether the instant object has been published previously. In keeping with this method 400, wherein private objects are segregated to a specific section of the memory, the private object memory section, for purposes of identification, the method may determine at block 402 whether the memory section in which the object to be published is located has been designated as a public object memory section, or, alternatively, not been designated as private object memory section. If not previously published, then the method 400 may proceed to block 404 wherein a memory section associated with the object is set to be a public object memory section, and the memory sections associated with objects reachable from the instant object are set as public object memory sections as well. At block 406, any objects that are not public are moved from the designated public object memory sections into a private memory section. Upon completion of the block 406, or upon the determination at block 402 that the instant object has been previously published, the method 400 may proceed to block 408, whereupon the instant object is published.

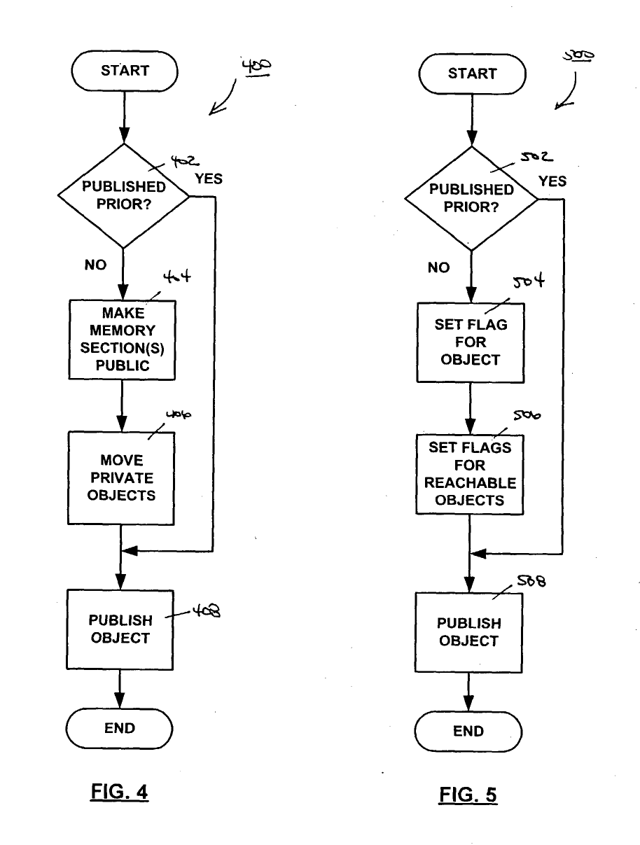

In FIG. 5, a method 500 is illustrated with a similar flowchart to that used in FIGS. 2-4, but illustrating a different method of identification than is shown in FIGS. 3 and 4. The method 500 may proceed to block 502 where a determination is made whether the instant object has been published previously. According to the method 500, identification is made by checking a flag that is associated with the instant object, and that has at least two states, public and non-public. If the flag is set, then the determination may be made that the object is public, while if the flag is not set, then the determination may be made that the object is non-public.

There may be a number of methods by which a flag may be associated with an object. FIG. 6 shows one example of a method by which a flag may be associated with an object. In particular, an object 600 may have a header 602. Within the header 602 may be a section 604 (for example, a byte) reserved for a lock-related information, and within the section 604 may be a subsection 606 (for example, a bit) that may be reserved for use in the method of FIG. 5. The subsection 606 may have a first state (e.g., 0) if the object is non-public, and be set to a second state (e.g., 1) is the object is public. One skilled in the art will recognize that other methods may be used to associate a flag with an object, such as a table with a plurality of entries, each entry representing a flag and associated with an object.

The method of FIG. 5 may continue at a block 504, if the determination of the block 502 indicates that the instant object has not been previously published. At the block 504, the flag associated with the instant object is set to a public state (e.g., 1 where the flag is represented by the subsection 606 of the header 602). At block 506, the method may determine those objects reachable from the instant object by implementing a recursive scan and may set the flags associated with the objects reachable from the instant object to a public state. The method 500 may then proceed to block 508, which may also be reached directly from block 502 if it is determined that the object has been previously published, and at the block 508, the instant object is published.

Regardless of the method of identification used, FIG. 7 illustrates a method of using the identification to select a lock acquisition technique. The method 700 may check if the object has been identified as public prior to establishing a lock on the object at blocks 702, 704. One skilled in the art will recognize that, although they are shown separately, the blocks 702, 704 may be combined into a single block.

At block 702, the method 700 may check the identification of the object. For example, in the methods of FIGS. 3 and 4, where objects are identified by the location in memory in which the objects are stored, the check may involve determining which section of the memory the instant object is stored. Alternatively, wherein the objects are identified through the use of a flag, as in the method of FIG. 5, the check may involve determining the state of the flag. Where the flag is represented as a bit, this check may involve determining if the flag is 0 or 1.

At block 704, the public or non-public classification of the object is determined based on the identification check performed previously. Where identification is according to placement in memory, for example, the placement in memory may be compared with the known memory location of public objects to determine if the object is public. As another example, wherein the identification is based on the state of a flag, the state of the flag may be compared with the known state for public objects to determine if the object is public.

Having made the determination at block 704 that the object is public or non-public, the method 700 may proceed to block 706 or block 708. If the determination is made a block 704 that the object is public, then an atomic RMW may be used to acquire the lock at block 706. Alternatively, if the determination is made a block 704 that the object is non-public, then a non-atomic acquisition technique may be used to acquire the lock at block 708, such as a store instruction.

It will also be recognized that a set of instructions for implementing the lock management method may be stored on a machine accessible medium. A machine accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine accessible medium includes recordable/non-recordable magnetic, optical and solid-state media (e.g., read only memory (ROM), programmable read only memory (PROM), erasable programmable read only memory (EPROM), electrically erasable programmable read only memory (EEPROM), random access memory (RAM), magnetic disk storage media, optical storage media, flash memory devices, etc.), as well as electrical, optical, acoustical or other form of propagated signals (e.g., carrier waves, infrared signals, digital signals, etc.), etc. According to the present embodiment, the machine-accessible medium may include the memory/data storage medium 113, the data storage medium 131, and/or the data storage medium 133.

One skilled in the art will appreciate that while the method described herein has been discussed as operating in combination with the write barrier of a generational garbage collection routine, it is not necessary that the method be used in combination with such a write barrier. One skilled in the art will appreciate that the method my be used with any set of instructions that performs the same write monitoring operation.

Moreover, one skilled in the art will appreciate that the identification of those objects that are non-public and/or of those objects that are public and the determination as to whether an object is non-public or public may be used in conjunction with other decision-making besides which instruction type to use for lock acquisition. For example, with objects identified as non-public and/or public, after a determination is made as to whether an object is non-public or public, a decision may be made whether to use a weaker or a stronger memory ordering model. For example, if the object is non-public, then a weaker memory ordering model may be used. If the object is public, then a stronger memory ordering model may be used.

Furthermore, the disclosed structures and methods have been described with reference to foregoing examples. It will, however, be evident that various modifications and changes may be made thereto without departing from the broader spirit and scope of this disclosure. The above specification and figures accordingly are to be regarded as illustrative rather than restrictive. Particular materials selected herein can be easily substituted for other materials that would be apparent to those skilled in the art and would nevertheless remain equivalent to the disclosed devices and methods.

What is claimed is:

1. A method comprising:
determining if an object has been published previously, identifying the object as public according to whether the object has been published previously;
identifying objects reachable from the object as public according to whether the object has been published previously; and
publishing the object.

2. The method according to claim 1, further comprising checking if the object has been identified as public prior to establishing a lock on the object.

3. The method according to claim 2, further comprising:
using an atomic read modify write instruction to acquire a lock if the object has been identified as public; and
using a non-atomic instruction to acquire a lock if the object has not been identified as public.

4. The method according to claim 1, further comprising:
setting a flag associated with the object to a public state according to whether the object has been published previously; and
setting flags associated with objects reachable from the object to a public state according to whether the object has been published previously;

5. The method according to claim 4, further comprising checking the flag associated with the object prior to establishing a lock on the object.

6. The method according to claim 5, further comprising:
using an atomic read modify write instruction to acquire a lock if the flag associated with the object has a public state; and
using a non-atomic instruction to acquire a lock if the flag associated with the object does not have a public state.

7. The method according to claim 6, further comprising:
using an atomic read modify write instruction if the flag associated with the object has a public state; and
using a non-atomic store instruction if the flag associated with the object does not have a public state.

8. The method according to claim 1, further comprising:
moving the object to a public object memory section according to whether the object has been published previously; and
moving objects reachable from the object to the public object memory section according to whether the object has been published previously.

9. The method according to claim 8, further comprising checking whether the object is in the public object memory section prior to establishing a lock on the object.

10. The method according to claim 9, further comprising:
using an atomic read modify write instruction to acquire a lock if the object is in the public object memory section; and
using a non-atomic instruction to acquire a lock if the object is not in the public object memory section.

11. The method according to claim 1, further comprising:
setting a memory section associated with the object to be a public object memory section according to whether the object has been published previously;
setting memory sections associated with objects reachable from the object to be public object memory sections according to whether the object has been published previously; and
moving objects that are not public out of the public object memory sections into a private object memory section.

12. The method according to claim 1, further comprising:
using a stronger memory ordering model if the object has been identified as public; and
using a weaker memory ordering model if the object has not been identified as public.

13. An apparatus comprising:
a processor operatively coupled to a machine accessible medium, the machine accessible medium providing instructions that, if executed by the processor, will cause the processor to perform operations comprising:
determining if an object has been published previously, identifying the object as public according to whether the object has been published previously;
identifying objects reachable from the object as public according to whether the object has been published previously; and
publishing the object.

14. The apparatus according to claim 13, the machine accessible medium providing instructions that, if executed by the processor, will cause the processor to perform operations comprising checking if the object has been identified as public prior to establishing a lock on the object.

15. The apparatus according to claim 14, the machine accessible medium providing instructions that, if executed by the processor, will cause the processor to perform operations comprising:
using an atomic read modify write instruction to acquire a lock if the object has been identified as public; and
using a non-atomic instruction to acquire a lock if the object has not been identified as public.

16. The apparatus according to claim 13, the machine accessible medium providing instructions that, if executed by the processor, will cause the processor to perform operations comprising:
setting a flag associated with the object to a public state according to whether the object has been published previously; and
setting flags associated with objects reachable from the object to a public state according to whether the object has been published previously;

17. The apparatus according to claim 16, the machine accessible medium providing instructions that, if executed by the processor, will cause the processor to perform operations comprising checking the flag associated with the object prior to establishing a lock on the object.

18. The apparatus according to claim 17, the machine accessible medium providing instructions that, if executed by the processor, will cause the processor to perform operations comprising:
using an atomic read modify write instruction to acquire a lock if the flag associated with the object has a public state; and
using a non-atomic instruction to acquire a lock if the flag associated with the object does not have a public state.

19. The apparatus according to claim 18, the machine accessible medium providing instructions that, if executed by the processor, will cause the processor to perform operations comprising:
using an atomic read modify write instruction if the flag associated with the object has a public state; and
using a non-atomic store instruction if the flag associated with the object does not have a public state.

20. The apparatus according to claim 13, the machine accessible medium providing instructions that, if executed by the processor, will cause the processor to perform operations comprising:
moving the object to a public object memory section according to whether the object has been published previously; and
moving objects reachable from the object to the public object memory section according to whether the object has been published previously.

21. The apparatus according to claim 20, the machine accessible medium providing instructions that, if executed by the processor, will cause the processor to perform operations comprising checking whether the object is in the public object memory section prior to establishing a lock on the object.

22. The apparatus according to claim 21, the machine accessible medium providing instructions that, if executed by the processor, will cause the processor to perform operations comprising:
using an atomic read modify write instruction to acquire a lock if the object is in the public object memory section; and
using a non-atomic instruction to acquire a lock if the object is not in the public object memory section.

23. The apparatus according to claim 13, the machine accessible medium providing instructions that, if executed by the processor, will cause the processor to perform operations comprising:
setting a memory section associated with the object to be a public object memory section according to whether the object has been published previously;
setting memory sections associated with objects reachable from the object to be public object memory sections according to whether the object has been published previously; and
moving objects that are not public out of the public object memory sections into a private object memory section.

24. The apparatus according to claim 13, the machine accessible medium providing instructions that, if executed by the processor, will cause the processor to perform operations comprising:
using a stronger memory ordering model if the object has been identified as public; and
using a weaker memory ordering model if the object has not been identified as public.

26. An article of manufacture comprising:
a machine accessible medium providing instructions that, if executed by a processor, will cause the processor to perform operations comprising:
determining if an object has been published previously,
identifying the object as public according to whether the object has been published previously;
identifying objects reachable from the object as public according to whether the object has been published previously; and
publishing the object.

27. The article according to claim 26, wherein the machine accessible medium provides instructions that, if executed by a processor, will cause the processor to perform operations comprising checking if the object has been identified as public prior to establishing a lock on the object.

28. The article according to claim 27, wherein the machine accessible medium provides instructions that, if executed by a processor, will cause the processor to perform operations comprising:
using an atomic read modify write instruction to acquire a lock if the object has been identified as public; and
using a non-atomic instruction to acquire a lock if the object has not been identified as public.

29. The article according to claim 26, wherein the machine accessible medium provides instructions that, if executed by a processor, will cause the processor to perform operations comprising:
setting a flag associated with the object to a public state according to whether the object has been published previously; and
setting flags associated with objects reachable from the object to a public state according to whether the object has been published previously;

30. The article according to claim 29, wherein the machine accessible medium provides instructions that, if executed by a processor, will cause the processor to perform operations comprising checking the flag associated with the object prior to establishing a lock on the object.

31. The article according to claim 30, wherein the machine accessible medium provides instructions that, if executed by a processor, will cause the processor to perform operations comprising:
using an atomic read modify write instruction to acquire a lock if the flag associated with the object has a public state; and
using a non-atomic instruction to acquire a lock if the flag associated with the object does not have a public state.

32. The article according to claim 31, wherein the machine accessible medium provides instructions that, if executed by a processor, will cause the processor to perform operations comprising:
using an atomic read modify write instruction if the flag associated with the object has a public state; and
using a non-atomic store instruction if the flag associated with the object does not have a public state.

33. The article according to claim 26, wherein the machine accessible medium provides instructions that, if executed by a processor, will cause the processor to perform operations comprising:
moving the object to a public object memory section according to whether the object has been published previously; and
moving objects reachable from the object to the public object memory section according to whether the object has been published previously.

34. The article according to claim 33, wherein the machine accessible medium provides instructions that, if executed by a processor, will cause the processor to perform operations comprising checking whether the object is in the public object memory section prior to establishing a lock on the object.

35. The article according to claim 34, wherein the machine accessible medium provides instructions that, if executed by a processor, will cause the processor to perform operations comprising:
using an atomic read modify write instruction to acquire a lock if the object is in the public object memory section; and
using a non-atomic instruction to acquire a lock if the object is not in the public object memory section.

36. The article according to claim 26, wherein the machine accessible medium provides instructions that, if executed by a processor, will cause the processor to perform operations comprising:
setting a memory section associated with the object to be a public object memory section according to whether the object has been published previously;
setting memory sections associated with objects reachable from the object to be public object memory sections according to whether the object has been published previously; and
moving objects that are not public out of the public object memory sections into a private object memory section.

37. The article according to claim 26, wherein the machine accessible medium provides instructions that, if executed by a processor, will cause the processor to perform operations comprising:
using a stronger memory ordering model if the object has been identified as public; and
using a weaker memory ordering model if the object has not been identified as public.
